(19) United States
(12) Patent Application Publication
(10) Pub. No.: US 2003/0128996 A1
(43) Pub. Date: Jul. 10, 2003

(54) Corona current attitude compensation system and method

(76) Inventor: Peter G. Fournia, Penfield, NY (US)

Correspondence Address: PERMAN & GREEN, 425 POST ROAD, FAIRFIELD, CT, 06824, US

(21) Appl. No.: 10/041,307

(22) Filed: Jan. 7, 2002

(51) Int. Cl. G03G 15/02

(52) U.S. Cl. 399/50; 399/170

(57) ABSTRACT

A parameter which is a function of ionization voltage of a first ionization device is displayed and/or used to control the ionization voltage of a second ionization device in accordance with altitude, pressure, or humidity. The first device can be a DC ionization device, e.g., a scorotron, while the second device can be an AC ionization device, e.g., a discorotron or a dicorotron. A third ionization device can also have its ionization voltage controlled by the first device ionization voltage. The invention can be used in a xerographic apparatus.

### CROSS-REFERENCES TO RELATED APPLICATIONS

The present invention is related to U.S. application Ser. No. 09/669,105, filed Sep. 25, 2000.

### STATEMENT REGARDING FEDERALLY SPONSORED RESEARCH OR DEVELOPMENT

Not Applicable

### BACKGROUND OF THE INVENTION

1. Field of the Invention

This invention relates generally to a development system as used in xerography, and more particularly, concerns a development system in which toner is conveyed to an electrostatic latent image by an AC field.

2. Description of the Related Art Including Information Disclosed Under 37 CFR 1.97 and 1.98

In a typical electrostatographic printing process, such as xerography, a photoreceptor (PR) is charged to a substantially uniform potential so as to sensitize the surface thereof. The charged portion of the photoreceptor is exposed to a light image of an original document being reproduced. Exposure of the charged photoreceptor selectively dissipates the charges thereon in the irradiated areas. This records an electrostatic latent image on the photoreceptor corresponding to the informational areas contained within the original document. After the electrostatic latent image is recorded on the photoreceptor, the latent image is developed by bringing a developer material into contact therewith. Generally, the developer material comprises toner particles adhering triboelectrically to carrier granules. The toner particles are attracted from the carrier granules to the latent image forming a toner powder image on the photoreceptor. The toner powder image is then transferred from the photoreceptor to a copy sheet. The toner particles are heated to permanently affix the powder image to the copy sheet. After each transfer process, the toner remaining on the photoconductor is cleaned by a cleaning process.

The charging is done by an ionization device, e.g., a corotron (a corona wire having a DC voltage and an electrostatic shield), a dicorotron (a glass covered corona wire with AC voltage, an electrostatic shield with DC voltage, and an insulating housing), a scorotron (a corotron with an added biased conducting grid), a discorotron (a dicorotron with an added biased conducting strip), or a pin scorotron (a corona pin array housing a high voltage and a biased conducting grid).

These devices provide ionization, which increases with altitude and provides increased performance. However, the higher ionization causes an excessive risk to reliability. The risk is caused by a higher degradation rate of the screen grid, shield surfaces, wire, and wire insulators, and a higher risk of arcs, ozone (O₃) generation (and the cost of filtering it), nitric oxide (NOₓ) generation with associated PR degradation, and a higher noise level.

These risks are commonly managed by lowering the corona emission at higher altitude. It is easily and automatically accomplished in a pin scorotron by controlling the pin current to be a constant value via the power supply. With this done, the resultant pin (ionization) voltage indirectly becomes an indicator of altitude.

Compensation for ionization at high altitude for a DC pin scorotron is very simple since pin current equals ionization current. Thus it is only necessary to control the pin current to a fixed value for all altitudes. This is commonly done in machines using DC pin scorotrons. Unlike the DC pin scorotron, the discorotron has 4 circuits compared to 3 in the pin scorotron. Furthermore, all of the discorotron ionizing circuits are AC. This makes control of the net ionization current which is extracted from the AC plasma very difficult.

It is therefore desirable to have an automatic system and method for controlling ionization in AC ionization devices.

### BRIEF SUMMARY OF THE INVENTION

A method comprises measuring ionization voltage in a first device.

Apparatus comprises a first ionization device and a voltage meter measuring ionization voltage in said first device.

### BRIEF DESCRIPTION OF THE SEVERAL VIEWS OF THE DRAWING(S)

FIG. 1 is a view of a xerographic copying machine incorporating the invention, and

FIG. 2 is a block diagram of the invention.

### DETAILED DESCRIPTION OF THE INVENTION

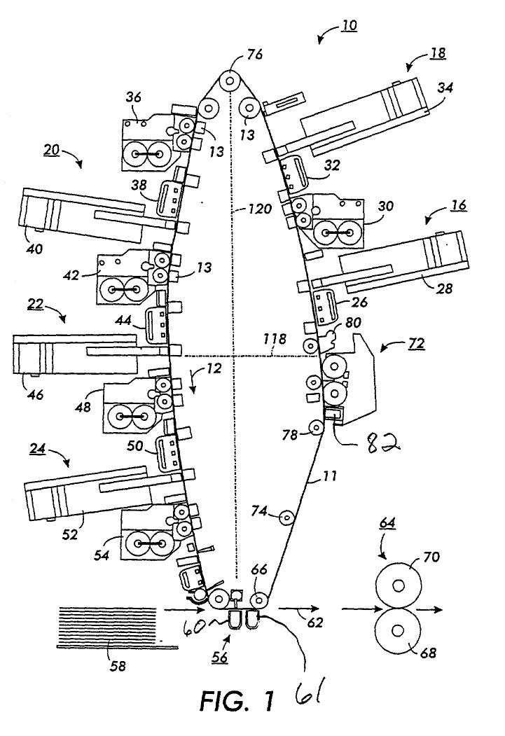

With reference to FIG. 1, there is shown a single pass multi-color printing machine 10. This printing machine employs a photoconductive belt 11, supported by a plurality of rollers or bars, 13. Photoconductive belt 11 is arranged in a vertical orientation, but any other orientation can be used with the present invention. Belt 11 advances in the direction of arrow 12 to move successive portions of the external surface of photoconductive belt 11 sequentially beneath the various processing stations disposed about the path of movement thereof. The photoconductive belt has a major axis 120 and a minor axis 118. The major and minor axes are perpendicular to one another. Photoconductive belt 11 is elliptically shaped, but any other shape can be used. The major axis 120 is substantially parallel to the gravitational vector and arranged in a substantially vertical orientation. The minor axis 118 is substantially perpendicular to the gravitational vector and arranged in a substantially horizontal direction. However, other orientations and directions can be used. The printing machine architecture includes five image recording stations indicated generally by the reference numerals 16, 18, 20, 22, and 24, respectively.

Initially, belt 11 passes through image recording station 16. Image recording station 16 includes an ionization device and an exposure device. The ionization device includes a corona device 26 that charges the exterior surface of photoconductive belt 11 to a relatively high, substantially uniform potential. After the exterior surface of photoconductive belt 11 is charged, the charged portion thereof advances to the exposure device. The exposure device includes a raster output scanner (ROS) 28, which illuminates the charged portion of the exterior surface of photoconductive belt 11 to record a first electrostatic latent image thereon. Alternatively, a light emitting diode (LED) may be used.

This first electrostatic latent image is developed by developer unit 30. Developer unit 30 deposits toner particles of a selected color on the first electrostatic latent image. After the highlight toner image has been developed on the exterior surface of photoconductive belt 11, belt 11 continues to advance in the direction of arrow 12 to image recording station 18.

Image recording station 18 includes an ionization device 32 and an exposure device. The ionization device includes a corona generator which recharges the exterior surface of photoconductive belt 11 to a relatively high, substantially uniform potential. The exposure device includes a ROS 34 which illuminates the charged portion of the exterior surface of photoconductive belt 11 selectively to record a second electrostatic latent image thereon. This second electrostatic latent image corresponds to the regions to be developed with, e.g., magenta, toner particles. This second electrostatic latent image is now advanced to the next successive developer unit 36.

Developer unit 36 deposits magenta toner particles on the electrostatic latent image. In this way, a magenta toner powder image is formed on the exterior surface of photoconductive belt 11. After the magenta toner powder image has been developed on the exterior surface of photoconductive belt 11, photoconductive belt 11 continues to advance in the direction of arrow 12 to image recording station 20.

If desired stations 16 and 18 can have two ionization devices.

Image recording station 20 includes two ionization devices and an exposure device. The ionization devices 38 include a pin scorotron having a DC corona generator and a discorotron having an AC corona generator. These ionization devices charge and recharge the photoreceptor surface to a relatively high voltage with very high uniformity. Control of these devices is described below. The exposure device includes ROS 40 which illuminates the charged portion of the exterior surface of photoconductive belt 11 to selectively dissipate the charge thereon to record a third electrostatic latent image corresponding to the regions to be developed with, e.g., yellow, toner particles. This third electrostatic latent image is now advanced to the next successive developer unit 42.

Developer unit 42 deposits yellow toner particles on the exterior surface of photoconductive belt 11 to form a yellow toner powder image thereon. After the third electrostatic latent image has been developed with yellow toner, belt 11 advances in the direction of arrow 12 to the next image recording station 22.

Image recording station 22 includes two ionization devices and an exposure device. The ionization devices 44 include a pin scorotron having a DC corona generator and a discorotron having an AC corona generator. These ionization devices charge and recharge the photoreceptor surface to a relatively high voltage with very high uniformity. The exposure device includes ROS 46, which illuminates the charged portion of the exterior surface of photoconductive belt 11 to record a fourth electrostatic latent image for development with, e.g., cyan, toner particles. After the fourth electrostatic latent image is recorded on the exterior surface of photoconductive belt 11, photoconductive belt 11 advances this electrostatic latent image to the cyan developer unit 48.

Cyan developer unit 48 deposits cyan toner particles on the fourth electrostatic latent image. These toner particles may be partially in superimposed registration with the previously formed yellow and magenta powder image. After the cyan toner powder image is formed on the exterior surface of photoconductive belt 11, photoconductive belt 11 advances to the next image recording station 24.

Image recording station 24 includes two ionization devices and an exposure device. The ionization devices 50 include a pin scorotron having a DC corona generator and a discrotron having an AC corona generator. These ionization devices charge and recharge the photoreceptor surface to a relatively high voltage with very high uniformity. The exposure device includes ROS 52, which illuminates the charged portion of the exterior surfaces of photoconductive belt 11 to selectively discharge those portions of the charged exterior surface of photoconductive belt 11 which are to be developed with black toner particles. The fifth electrostatic latent image, to be developed with, e.g., black, toner particles, is advanced to black developer unit 54.

At black developer unit 54, black toner particles are deposited on the exterior surface of photoconductive belt 11. These black toner particles form a black toner powder image which may be partially or totally in superimposed registration with the previously formed cyan, yellow, and magenta toner powder images. In this way, a multi-color toner powder image is formed on the exterior surface of photoconductive belt 11. Thereafter, photoconductive belt 11 advances the multi-color toner powder image to a transfer station, indicated generally by the reference numeral 56.

At transfer station 56, a receiving medium, i.e., paper, is advanced from stack 58 by sheet feeders and guided to transfer station 56. At transfer station 56, an ionization generating device 60 sprays ions onto the back side of the paper. This attracts the developed multi-color toner image from the exterior surface of photoconductive belt 11 to the sheet of paper. Stripping axis roller 66 contacts the interior surface of photoconductive belt 11 and provides a sufficiently sharp bend thereat so that the beam strength of the advancing paper strips from photoconductive belt 11. This is aided by detacking ionization device 61. A vacuum transport moves the sheet of paper in the direction of arrow 62 to fusing station 64.

Fusing station 64 includes a heated fuser roller 70 and a back-up roller 68. The back-up roller 68 is resiliently urged into engagement with the fuser roller 70 to form a nip through which the sheet of paper passes. In the fusing operation, the toner particles coalesce with one another and bond to the sheet in image configuration, forming a multi-color image thereon. After fusing, the finished sheet is discharged to a finishing station where the sheets are compiled and formed into sets which may be bound to one another. These sets are then advanced to a catch tray for subsequent removal therefrom by the printing machine operator.

One skilled in the art will appreciate that while the multi-color developed image has been disclosed as being transferred to paper, it may be transferred to an intermediate member, such as a belt or drum, and then subsequently transferred and fused to the paper. Furthermore, while toner powder images and toner particles have been disclosed herein, one skilled in the art will appreciate that a liquid developer material employing toner particles in a liquid carrier may also be used. Tensioning roll 74 is mounted slidably on brackets. A spring (not shown) resiliently urges tensioning roll 74 into contact with the interior surface of photoconductive belt 11 to maintain belt 11 at the appropriate tension.

Invariably, after the multi-color toner powder image has been transferred to the sheet of paper, residual toner particles remain adhering to the exterior surface of photoconductive belt 11. The photoconductive belt 11 moves over isolation roller 78 which isolates the cleaning operation at cleaning station 72. At cleaning station 72, which can include an ionization device 82 similar to device 60, the residual toner particles are removed from photoconductive belt 11. The belt 11 then moves under spots blade 80 to also remove toner particles therefrom.

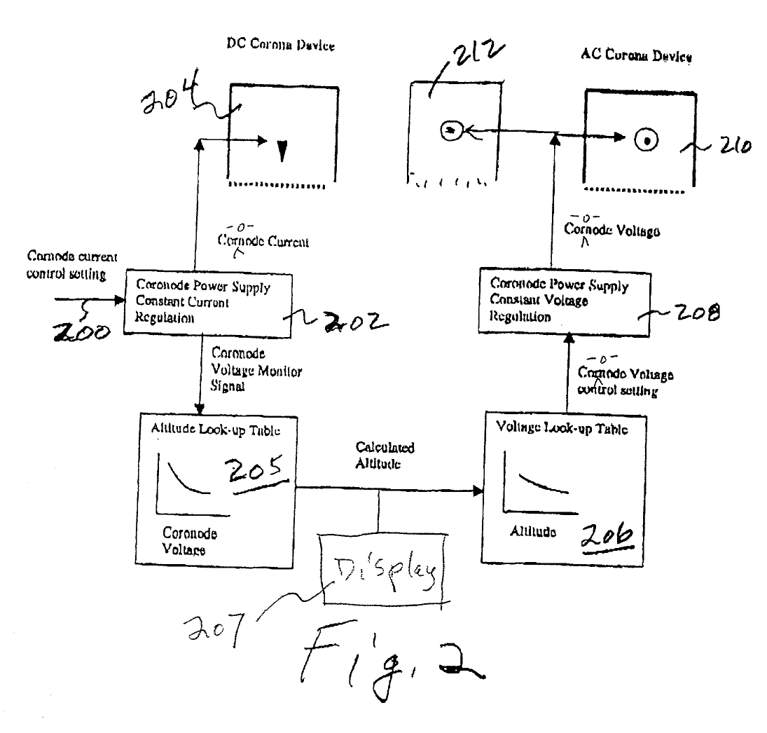

FIG. 2 shows one of the ionization devices 38, 44 and 50. The corona generating element of a corona device is known as a “coronode” An initial coronode current control setting signal from a machine control memory (or any other source) on line 200 is provided to a current regulated power supply 202. In turn, power supply 202 provides a constant current to the coronode of the first ionization device, e.g., a pin scorotron 204, as known in the art. Supply 202 also provides a signal representing the ionization voltage to an altitude look up table (LUT) 205. A signal representing a parameter which is a function of said measured ionization voltage, e.g., the looked up altitude, is supplied by LUT 205 to a voltage LUT 206. The signal representing the altitude can also be applied to a utilizer such as optional display 207. In turn, LUT 206 supplies a coronode (ionization) voltage control setting signal to a utilizer such as controller or voltage regulated power supply 208. LUTs 205 and 206 are preprogrammed with their respective functions as empirically determined. If desired, LUTs 205 and 206 can be combined into a single LUT (not shown). Supply 208 provides ionization voltage to the coronode of the second ionization device, e.g., a discorotron 210. Optionally, the ionization voltage can also be applied to the coronode of a third ionization device 212. Further, more, or even all, coronodes of ionization devices 38, 44, and 50 can be controlled by the voltage on the first device 204 by being supplied by the power supply 208 or other power supplies (not shown). Also, other ionization devices, e.g., devices 60 and/or 82 can be controlled in place of, or in addition to, devices 38, 44 and 50. Ionization devices 204, 210, and 212 are disposed proximate belt 11.

It will therefore be appreciated that DC scorotron 204 with constant current power supply 202 will automatically adjust its voltage so as to maintain a fixed ionization current. This will essentially compensate for air pressure, water vapor content or any other composition of the air that effects its ability to be ionized. The voltage is a unique indicator of ionization and is therefore a signal that is used to adjust other corona devices (such as the AC corona devices 210 and 212). This results in higher reliability due to less component degradation, lower risk of arcing and O₃ generation, and less noise and lost.

While the present invention has been particularly described with respect to preferred embodiments, it will be understood that the invention is not limited to these particular preferred embodiments, the process steps, the sequence, or the final structures depicted in the drawings. On the contrary, it is intended to cover all alternatives, modifications, and equivalents as may be included within the spirit and scope of the invention defined by the appended claims. In addition, other methods and/or devices may be employed in the method and apparatus of the instant invention as claimed with similar results. In particular, the present invention can be used to control ionization potential for changes in barometric pressure and/or humidity at a fixed altitude by appropriately programming LUTs 205 and 206. Further different colors, e.g., red, blue, green, and black can be used for printing. Also, the invention can be used in a monochrome (black and white) copier. Still further, the invention can be used to just measure or indicate altitude and/or pressure, e.g., using display 207, without controlling any other device.

What is claimed is:

1. A method comprising:
measuring ionization voltage in a first device; and
using said measured ionization voltage.

2. The method of claim 1, wherein said using step comprises controlling ionization voltage in a second device in accordance with said measured voltage.

3. The method of claim 1, wherein said first device comprises a scorotron.

4. The method of claim 1, wherein said first device comprises a corotron.

5. The method of claim 2, wherein said second device comprises a discorotion.

6. The method of claim 2, wherein said second device comprises a dicorotron.

7. The method of claim 2, wherein said ionization voltage is a function of altitude and said controlling step controls said second device ionization voltage as a function of altitude.

8. The method of claim 2, further comprising controlling ionization voltage in a third device in accordance with said measured voltage.

9. The method of claim 1, wherein said using step comprises displaying a parameter which is a function of said measured ionization voltage.

10. The method of claim 9, wherein said parameter comprises altitude.

11. Apparatus comprising:
a first ionization device;
a voltage meter measuring ionization voltage in said first device; and
a utilizer for said ionization voltage.

12. The apparatus of claim 11, further comprising:
a second ionization device; and said utilizer includes a controller controlling the ionization voltage of said second device in accordance with the measured ionization voltage.

13. The apparatus of claim 11, wherein said first device comprises a scorotron.

14. The apparatus of claim 11, wherein said first device comprises a corotron.

15. The apparatus of claim 12, wherein said second device comprises a discorotron.

16. The apparatus of claim 12, wherein said second device comprises a dicorotron.

17. The apparatus of claim 12, wherein said first device ionization voltage is a function of altitude and said controller controls said second device ionization voltage as a function of altitude.

18. The apparatus of claim 12, further comprising a third ionization device, said controller controlling the ionization voltage of said third device in accordance with the measured voltage.

19. The apparatus of claim 11, wherein said utilizer comprises a display for a parameter which is a function of said measured ionization voltage.

20. The apparatus of claim 19, wherein said parameter comprises altitude.

21. Xerographic apparatus comprising:
a photoconductive belt; and
at least one image recording station disposed near said belt and including a charging device and an exposure device, said charging device comprising:
a first ionization device;
a voltage meter measuring ionization voltage in said first device; and
a utilizer for said ionization voltage.

22. The apparatus of claim 21, further comprising a second ionization device; and
said utilizer includes a controller controlling the ionization voltage of said second device in accordance with the measured voltage.

23. The apparatus of claim 21, wherein said first device comprises a scorotron.

24. The apparatus of claim 21, wherein said first device comprises a corotron.

25. The apparatus of claim 22, wherein said second device comprises a discorotron.

26. The apparatus of claim 22, wherein said second device comprises a dicorotron.

27. The apparatus of claim 22, wherein said first device ionization voltage is a function of altitude and said controller controls said second device ionization voltage as a function of altitude.

28. The apparatus of claim 22, further comprising a third ionization device, said controller controlling the ionization voltage of said third device in accordance with the measured voltage.

29. The apparatus of claim 22, wherein said utilizer comprises a display for a parameter which is a function of said measured ionization voltage.

30. The apparatus of claim 29, wherein said parameter comprises altitude.
